(19) United States
(12) Patent Application Publication
(10) Pub. No.: US 2008/0040334 A1
(43) Pub. Date: Feb. 14, 2008

(54) Operation of Relational Database Optimizers by Inserting Redundant Sub-Queries in Complex Queries

(76) Inventors: Gad Haber, Nesher (IL); Andre Heilper, Haifa (IL); Ariel Landau, Nesher (IL); Nattavut Sutyanyong, Thornhill (CA); Gary Valentin, Tel-Aviv (IL); Calisto Zuzarte, Pickering (CA)

Correspondence Address: Stephen C. Kaufman;IBM CORPORATION, Intellectual Property Law Dept., P.O. Box 218, Yorktown Heights, NY, 10598, US

(21) Appl. No.: 11/463,314

(22) Filed: Aug. 9, 2006

(51) Int. Cl. G06F 17/30

(52) U.S. Cl. 707/4

(57) ABSTRACT

Methods and systems are provided to facilitate the optimization process of existing relational database managers when processing complex queries. Specialized constraining clauses are inserted in or added to SQL queries, which do not affect the semantics of the queries. This operation causes the RDBMS to partition the query into sub-queries, and to apply a more efficient optimization for each sub-query. A condition in which the execution time of the modified query substantially exceeds that of the original query may indicate a design flaw in the RDBMS query optimizer.

### BACKGROUND OF THE INVENTION

1. Field of the Invention

This invention relates to database management systems. More particularly, this invention relates to performance improvements in queries directed to relational database management systems.

2. Description of the Related Art

Databases are computerized information storage and retrieval systems. A relational database management system (RDBMS) is a database management system that uses relational techniques for storing and retrieving data. RDBMS software using a Structured Query Language (SQL) interface is well known in the art. The SQL interface has evolved into a standard language for RDBMS software and has been adopted as such by both the American National Standards Organization (ANSI) and the International Standards Organization (ISO).

In RDBMS software all data is externally structured into tables. The SQL interface allows users to formulate relational operations on the tables interactively, in batch files, or embedded in a host language such as C or Java™. Operators are provided in SQL, which allow the user to manipulate the data, wherein each operator operates on either one or two tables and produces a new table as a result. The power of SQL lies on its ability to link information from multiple tables or views together to perform complex sets of procedures with a single statement. One of the most common SQL queries executed by RDBMS software is the SELECT statement. In the SQL standard, the SELECT statement generally has the format:
“SELECT<clause>FROM<clause>WHERE<clause>GROUP BY<clause>HAVING<clause>ORDER BY<clause>.”
   The clauses generally must follow this sequence. Only the SELECT and FROM clauses are required and all other clauses are optional.

Generally, the result of a SELECT statement is a subset of data retrieved by the RDBMS software from one or more existing tables stored in the relational database, wherein the FROM clause identifies the name of the table or tables from which data is being selected. The subset of data is treated as a new table, termed the result table. The WHERE clause determines which rows (records) should be returned in the result table. Generally, the WHERE clause contains a search condition that must be satisfied by each row returned in the result table. The rows that meet the search condition form an intermediate set, which is then processed further according to specifications in the SELECT clause.

The search condition typically comprises one or more predicates, each of which specifies a comparison between two values from certain columns, constants or correlated values. Alternatively, the predicates may be set-clauses, e.g., IN, NOT IN. Multiple predicates in the WHERE clause are typically connected by Boolean operators.

The SELECT statement may also include a grouping function indicated by the GROUP BY clause. The GROUP BY clause causes the rows in the intermediate result set to be grouped according to the values specified in the clause. A number of column or aggregate functions are also built into SQL, such as MAX (maximum value in column), MIN (minimum value in column), AVG (average of values in column), SUM (sum of values in column), and COUNT (number of rows).

Queries using aggregate expressions return as many result rows as there exist unique “result groups” in the source of the aggregation. A result group is defined as the set of values contained in the fields of a row corresponding to the list of columns or expressions specified in the GROUP BY clause of the query. The value of the aggregate function is the result of applying the function to the result of the contained expression for each row having the same result group.

Another operation permitted by SQL is the JOIN operation, which concatenates horizontally all or parts of two or more tables to create a new resulting table. The JOIN operation is implied, for example, by naming more than one table in the FROM clause of a SELECT statement. Alternatively, the JOIN operation may be specified explicitly.

A SQL query generally includes at least one predicate, which is a SQL expression that can assume a logical value of TRUE, FALSE, or UNKNOWN. A predicate typically either specifies a data range, tests for an existence condition, tests for equivalence, or performs a similar table comparison operation.

In a RDBMS, columns of any type can assume NULL (i.e., unknown) values. In RDBMS software, NULL values are properly handled using tri-value logic (i.e., TRUE, FALSE or UNKNOWN) for predicates, and in particular, SQL-based RDBMS's employ such logic. Columns of a RDBMS table, whose entries can assume NULL values, are referred to as nullable columns.

Nested SQL statements may require tuple-by-tuple data manipulation in each subquery for evaluation of the complete statement. For example, each entry of a table column may need to be compared against each entry of a corresponding column in another table to determine if a SELECT operation should retrieve a table row. Such tuple-by-tuple operations are very inefficient and require simplification and optimization.

A number of proposals have been made to improve query execution in a RDBMS. In U.S. Pat. No. 6,996,557 to Leung et al., a query is analyzed to determine whether it includes a predicate for matching nullable operands. If so, it is transformed to return TRUE when all operands are NULL. If the RDBMS supports the new function, the predicate is marked. If not, the predicate is re-written into a CASE expression having two SELECT clauses. The query is then executed.

In U.S. Pat. No. 6,581,055 to Ziauddin, et al., switch predicates are added to a query in order to determine which query execution plan or sub-plan (generated by a query optimizer) is executed. Different possibilities may be addressed in different sub-queries of an expanded query. Switch predicates are added to one or more sub-queries to determine which one(s) will execute, based on the run-time condition.

### SUMMARY OF THE INVENTION

An embodiment of the invention provides a computer-implemented method for evaluating a relational database management system having a query optimizer by optimizing a query, which when executed, retrieves data from a relational database. The method is carried out by determining that the query contains a qualifying clause, modifying the query by adding a redundant clause thereto to produce a modified query, thereafter executing the query and the modified query in the relational database management system, and evaluating the query optimizer responsively to a difference in a performance measurement of the relational database management system in executing the modified query and executing the query.

Another embodiment of the invention provides a computer software product for evaluating a relational database management system having a query optimizer by optimizing a query to retrieve data from a relational database in a storage device. The product includes a tangible computer-readable medium in which computer program instructions are stored, which instructions, when read by a computer, cause the computer to determine that the query contains a qualifying clause, modify the query by adding a redundant clause thereto to produce a modified query, thereafter execute the query and execute the modified query in the relational database management system, and evaluate the query optimizer responsively to a difference in a performance measurement of the relational database management system with respect to the executions of the query and the modified query.

Yet another embodiment of the invention provides a relational database management system that includes a query optimizer, a storage device having a relational database stored therein, and a processor executing a program for receiving a query and responsively to the query searching the relational database to retrieve data therefrom. The program includes a query pre-processor operative to: determine that the query contains a qualifying clause; modify the query by adding a redundant clause thereto to produce a modified query; thereafter execute the query and the modified query in the relational database management system, and evaluate the query optimizer responsively to a difference in a performance measurement of the relational database management system with respect to the executions of the query and the modified query.

An embodiment of the invention provides a computer-implemented method for validating a query optimizer of a relational database management system that is linked to a relational database in a storage device, which is carried out by formulating a first query to retrieve data from the relational database, modifying the first query by adding a redundant clause thereto to produce a second query, submitting the first query to the relational database management system, recording an execution time of the first query, submitting the second query to the relational database management system, recording an execution time of the second query, determining that the execution time of the second query exceeds the execution time of the first query, and responsively to the determination, concluding that a design flaw exists in the query optimizer.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a pictorial diagram illustrating an arrangement of computers, which is suitable for application of the concepts of the present invention;

FIG. 2 is a flow chart of a method for modifying a SQL query in accordance with a disclosed embodiment of the invention;

FIG. 3 is a flow diagram illustrating a method for improving the operation of a relational database in accordance with a disclosed embodiment of the invention; and

FIG. 4 is two graphs comparing execution times for exemplary queries plotted for different sizes of a table in a relational database, in accordance with a disclosed embodiment of the invention.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code, which embodies aspects of the present invention, is typically maintained in permanent storage, such as a computer readable medium. In a client-server environment, such software programming code may be stored on a client or a server. The software programming code may be embodied on any of a variety of known tangible media for use with a data processing system. This includes, but is not limited to, magnetic and optical storage devices such as disk drives, magnetic tape, compact discs (CD's), digital video discs (DVD's). In addition, while the invention may be embodied in computer software, the functions necessary to implement the invention may alternatively be embodied in part or in whole using hardware components such as application-specific integrated circuits or other hardware, or some combination of hardware components and software. Alternatively, the software programming code and computer instruction may be provided as signals embodied in a transmission medium, with or without a carrier wave upon which the signals are modulated. For example, the transmission medium may include a communications network, such as the Internet.

### System Overview.

In a RDBMS, users submit queries that cause information to be retrieved from the relational database. An optimizer in the RDBMS optimizes the query and generates an efficient execution plan. Typically, the optimizer adopts a costbased approach wherein the optimizer generates many possible alternative execution plans, and selects the “best” plan among the alternatives. The following detailed description sometimes references SQL and SQL queries. However, this is by way of example. The principles of the invention are applicable to other query languages that use similar semantics.

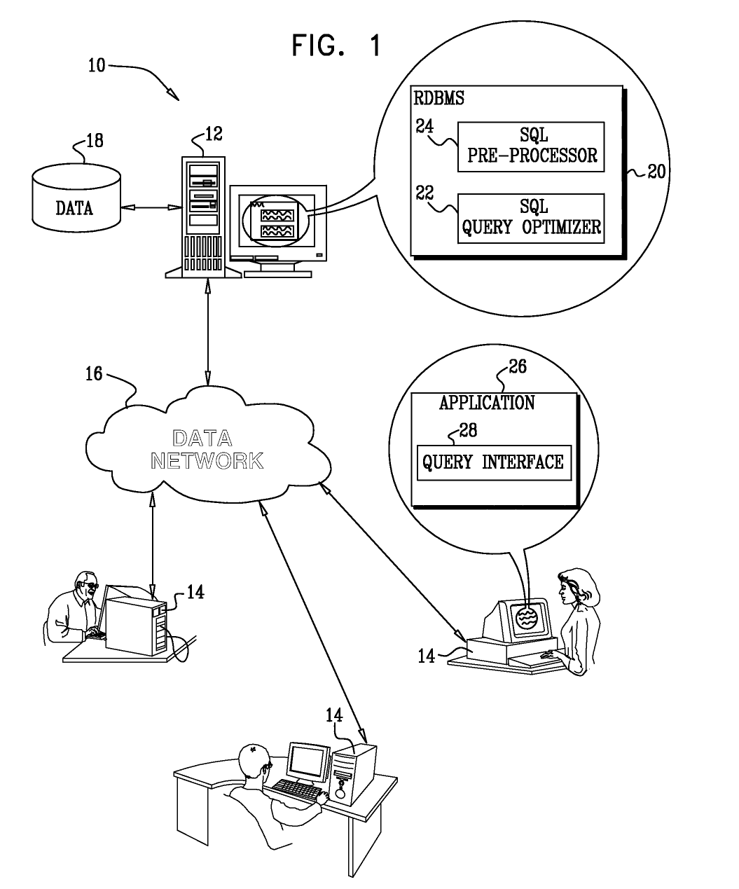

Turning now to the drawings, reference is initially made to FIG. 1, which is a pictorial diagram illustrating a system 10 of computers, which is suitable for application of the concepts of the present invention. The system 10 is a networked arrangement, which is convenient for explaining the principles of the invention. However, the invention is not limited to the particular arrangement shown, but is applicable to many combinations of computers and servers, including distributed file systems and databases. Indeed, the invention can be equally practiced using a single computer without external links.

A server 12 is linked to any number of clients 14 via a communications network 16. The network 16 can be any type of private or public network, such as a local area network, or the Internet. The server 12 has access to generic memory storage, which stores a database 18. The database 18 is a generic relational database, organized as tables, as is well-known in the art. The database 18 need not be embodied in a single physical unit, nor need it be directly connected with the server 12 as shown in FIG. 1. It can be integral with the server 12, or can be realized as one or more remote network elements connected to the server 12 via the network 16 or via a different network (not shown).

The server 12 and the clients 14 typically comprise general-purpose or embedded computer processors, which are programmed with suitable RDBMS software for carrying out the functions described hereinbelow. Thus, although the server 12 and the clients 14 are shown in FIG. 1 as comprising a number of separate functional blocks, these blocks are not necessarily separate physical entities, but rather represent different computing tasks. These tasks may be carried out in software running on a single processor, or on multiple processors. As noted above, the software may be provided to the processor or processors in electronic form, for example, over a network, or it may be furnished on tangible media, such as CD-ROM or non-volatile memory. Alternatively or additionally, the at least a portion of the server 12 and the clients 14 may comprise a digital signal processor (DSP) or hard-wired logic.

The server 12 executes a RDBMS 20, which is capable of recognizing and processing queries regarding the database 18 from the clients 14. Many RDBMS's are suitable for use as the RDBMS 20, including DB2®, available from IBM Corporation, New Orchard Road, Armonk, N.Y. 10504. The RDBMS 20 includes a query optimizer 22, which is typically a SQL query optimizer, and which selects the most efficient approach to the execution of the query arriving from the clients 14. Many query optimizers are known. The principles of the invention can be applied using any of them, whether they take a cost-based or rule-based approach to optimization, or some combination thereof. It is known, however, that the optimizations developed by the query optimizer 22 are often not perfect. The inventors have discovered that the response time of the RDBMS 20 can be substantially enhanced by pre-processing client queries, as will be apparent from the detailed description hereinbelow. Such pre-processing can be accomplished by textually editing SQL clauses of the client queries. Alternatively, modifications can be mode to other representations of the queries that are functionally equivalent to textual query edits. Pre-processing is represented in FIG. 1 as a separate SQL pre-processor 24 for conceptual clarity. However, the pre-processor 24 need not be a separate module, but can be realized by suitable modifications to the query optimizer 22. Alternatively, the query pre-processing can occur in the clients 14.

The clients 14 typically submit queries to the RDBMS 20 using a computer application 26, which is shown representatively in FIG. 1 for one of the clients 14. The clients 14 need not execute the same application. Indeed, they can execute a plurality of different applications simultaneously, in many combinations. Generally, a query interface 28 is provided by the application 26 for construction of a query, which generally is a SQL query. The query interface 28 can be as simple as a command line interface, or can be elaborately customized according to the features of the particular application 26 or the structure of the database 18.

### Problematic SQL Queries.

SQL queries that require join or anti-join operations take a significant time to complete. For example, the following algebraic expression:

A.X—(B.X“.C.X”.D.X),

which has the following SQL form:

### Query 1

SELECT X FROM A WHERE X NOT IN
((SELECT X FROM B) OR
(SELECT X FROM C) OR
(SELECT X FROM D)),
   may cause the database manager to apply the join operation:
(B x C x D)
   in order to compute all the records. Rewriting Query 1 into an expression that successfully avoids a full application of the join operation (or one of its variations such as anti-join) substantially improves performance, in some cases by an order of magnitude.

This can be accomplished by adding or inserting constraining clauses to certain SQL queries, which do not affect the semantics of the queries. This facilitates the optimization process of existing relational database managers when processing complex queries. More particularly, aspects of the invention involve addition of redundant clauses into subqueries preceded by “IN” or “NOT IN” operators, which specify inclusion or exclusion of a set of field values in a set of records. The queries are semantically unaltered by the new clauses. Thus, the original and modified queries should return the same information.

The requirements of a query to be modified is as follows:

Some queries contain other queries inside them as “embedded sub-queries”. For example, consider Query 2 and Query 3:

### Query 2

SELECT B.X FROM B

### Query 3

SELECT A.X FROM A WHERE X NOT IN (SELECT B.X FROM B).

Query 2 is an embedded sub-query of Query 3. Each sub-query starts with the SELECT keyword and follows the rules of a legal SQL query, as explained above in the discussion of nested SQL statements. Aspects of the invention apply to SQL queries containing sub-queries preceded by the IN or NOT IN operators.

Thus modified, a RDBMS is induced to partition the query into sub-queries, and to apply a more efficient optimization for each sub-query. In some queries, it is believed that the query modifications explained herein enable the algorithms used by the RDBMS to shift from using relational algebra to a more efficient Boolean algebra. In particular, expensive join (or anti-join) operations are replaced by regular set-theoretic operations, e.g., union, intersection and complement. Such a shift would ordinarily be improbable for non-fully optimized database managers in the absence of the query modifications.

The optimizations described herein do not require existing RDBMS optimizers to be altered. Rather, they are supplemental to any existing optimizing techniques already implemented in RDBMS managers.

### SQL Query Modification.

Assuming there are two database tables, A and B. with a column X of identical, or at least comparable types, such that a record present in column A.X (i.e., column X of table A), can be sought for also in column B.X. A straightforward SQL query for retrieving the difference set (A.X−B.X) is as follows.

### Query 4

SELECT X FROM A WHERE X NOT IN (SELECT X FROM B)

Unfortunately, the time performance of Query 4 is sometimes poor, as the RDBMS engine first computes the join operation of A.X and B.X, and only then compute the set difference A.X−B.X. In general, the join operation is hard to optimize when nullable columns are involved.

In contrast, the following query, which is logically equivalent to Query 4, shows significantly improved performance time even when columns A.X and B.X are nullable.

### Query 5

SELECT A.X FROM A WHERE
(A.X IS NOT NULL AND A.X NOT IN (SELECT A.X FROM B WHERE A.X=B.X) AND (SELECT COUNT (*) FROM B WHERE B.X IS NULL)=0) OR (SELECT COUNT (*) FROM B)=0

It will be seen from the examples below that Query 5 may substantially outperform Query 4. The reason for this is that the form of Query 5 enables the query optimizer 22 (FIG. 1) to differentiate several cases requiring different treatment:

Case 1: Table B is empty, i.e., Table B contains no record entries at all. The result of Query 4 is all of Table A. This case is represented in Query 5 by the following constraining clause:
(SELECT COUNT (*) FROM B)=0.

Case 2: Table B is not empty. This case has several possibilities:

Case 2.1: There are null records in Table B, i.e., If Table B contains at least one null record in B where B.X is not null, then the result of query #1 must be empty, as there is no record at all in Table A for which it can be asserted that it is not in Table B.

Case 2.2: There are no null records in Table B. This case is represented in Query 5 by the clause:
(SELECT COUNT (*) FROM B WHERE B.X IS NULL)=0.

### There are two possibilities for case 2.2.

Case 2.2.1: A.X is null. A.X cannot be in the result set as we cannot say that any such record is not present in Table B.

Case 2.2.2: A.X is not null. In this case, the difference

A.X−(A.X≧B.X)

is computed using conventional optimization methods, e.g., according to a standard RDBMS implementation. These do not need to take into account issues of nullable columns. This case is represented in Query 5 by the clause:
A.X NOT IN (SELECT A.X FROM B WHERE A.X=B.X). Nevertheless, even without the application of the algorithm described below, a performance step-up can often be achieved by the restatement of A.X−B.X into A.X−(A.X≧B.X).

The performance difference becomes even more impressive when dealing with more demanding queries, e.g.,

### Query 6

A.X−(B.X″.C.X″.D.X).

### In this case, converting Query 6 into Query 7 can make a significant difference in performance.

### Query 7

A.X−((A.X>B.X)″(A.X>C.X)″(A.X>D.X))

This strategy takes advantage of the fact that SQL joins are commutative and associative. The transformation of Query 6 into Query 7 is possible only when the special cases 1 and 2 (and the variants of case 2) occurring in Query 6 can be set apart as subqueries.

In general, adding constraining SQL clauses to SQL queries can significantly improve time performance, particularly where nullable columns are referenced. This technique does not replace an existing query optimizer in a RDBMS. Rather, the added constraining clauses encourage the existing RDBMS system to formulate a more efficient execution plan for the query. The technique is supplementary to any existing optimizations that may have been implemented within the existing RDBMS.

Modification of queries by the addition or insertion of redundant constraining clauses produces an apparently more complex, but logically equivalent query. That is, after adding or removing the code, the semantics of the original query and the modified query are identical. The modified query causes the RDBMS to create a partitioning into sub-queries (cases), and to apply a more efficient optimization for each sub-query.

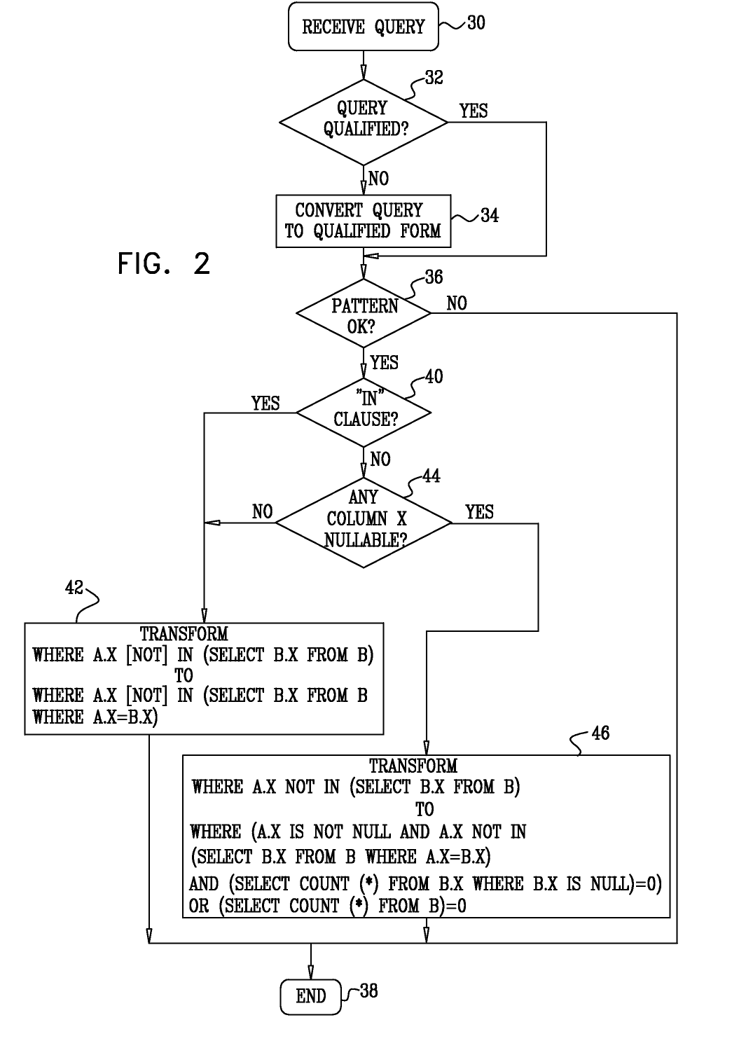

Reference is now made to FIG. 2, which is a flow chart of a method for modifying a SQL query in accordance with a disclosed embodiment of the invention. At initial step 30 a query is to be presented to a RDBMS for execution.

Control now proceeds to decision step 32, where it is determined if the query is in a qualified form. If one writes the query:

### Query 8

SELECT X FROM B.

the reference to column X is not qualified, because the term “column X”, does not explicitly state to which table column X belongs.

The qualified equivalent would be:

### Query 9

SELECT B.X FROM B.

which is logically equivalent to the “not qualified” version, Query 8. Indeed, even in the not qualified version, it can be unambiguously determined, according to SQL standards, that X must be a column of table B.

If the determination at decision step 32 is negative, then control proceeds to step 34, in which the query is converted to a qualified form. Creation of a qualified SQL query is well-known in the art. The details are therefore not repeated here. In the case of Query 10, the result would be Query 11.

### Query 10

DELETE FROM A WHERE X NOT IN (SELECT X FROM B).

### Query 11

DELETE FROM A WHERE A.X NOT IN (SELECT B.X FROM B).

If the determination at decision step 32 is affirmative, or after completion of step 34, control proceeds to decision step 36, where it is determined if the query pattern is appropriate for application of the steps described below. This requires the presence of a qualifying clause in the query, that is at least an “IN” clause or a “NOT IN” clause. Typically, such IN or NOT IN clauses conform to the one of the patterns 1, 2. Here the terms A and B represent tables, and A.X, B.X represent columns of a comparable type in the tables A and B, respectively. Terms enclosed in square brackets are optional.

Pattern 1: SELECT A.X FROM A WHERE A.X [NOT] IN (SELECT B.X FROM B)

Pattern 2: DELETE FROM A WHERE A.X [NOT] IN (SELECT B.X FROM B)

For example, Query 11 conforms to Pattern 2.

If the determination at decision step 36 is negative, then control proceeds to final step 38. The query is not appropriate for application of the steps described below, and the procedure terminates.

If the determination at decision step 36 is affirmative, then control proceeds to decision step 40, where it is determined if the query is of the type having an “IN” clause.

If the determination at decision step 40 is affirmative, then control proceeds to step 42. Here, a constraining clause of the following form is added. Each clause of the query having the form

### Query 12

WHERE A.X [NOT] IN (SELECT B.X FROM B)

becomes

### Query 13

WHERE A.X [NOT] IN (SELECT B.X FROM B WHERE A.X=B.X)

If the determination at decision step 40 is negative, then the query has a “NOT IN” clause. Control proceeds to decision step 44, after which constraining clauses may be added. The form of the constraining clauses is different, according to whether any of the columns A.X or B.X is nullable. At decision step 44, a determination is made whether any subject column (A.X or B.X) is a nullable column.

If the determination at decision step 44 is negative, then control proceeds to step 42. After the modifications made in step 42, the query will be processed conventionally, using whatever optimizations of the RDBMS manager are in effect. It should be noted that the “[NOT]” operator is never applied when step 42 is reached via an affirmative determination in decision step 40. The [NOT] operator is always applied when step 42 is reached via a negative determination in decision step 44.

If the determination at decision step 44 is affirmative, then control proceeds to step 46. Here, a different type of constraining clause of the following form is added, applying only to queries of “NOT IN” type. Each clause of the query having a “NOT IN” clause

### Query 14

WHERE A.X NOT IN (SELECT B.X FROM B)

becomes:

Query 15

```
WHERE (
  A.X IS NOT NULL
  AND A.X NOT IN (SELECT B.X FROM B WHERE A.X = B.X)
  AND (SELECT COUNT (*) FROM B.X
    WHERE B.X IS NULL) = 0
)
  OR (SELECT COUNT (*) FROM B) = 0
```

After performance of either step 42 or step 46, the procedure ends at final step 38. It will be understood that the procedure may be iterated, when the patterns 1, 2 recur in nested queries, possibly with different columns, some of which may be nullable and others not.

### Operation.

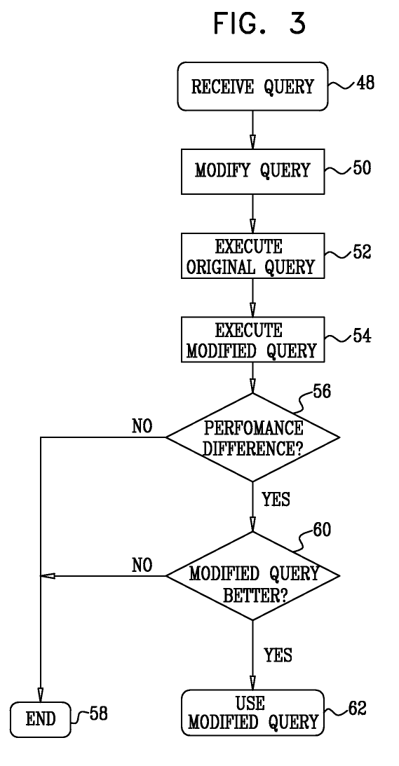

Reference is now made to FIG. 3, which is a flow diagram illustrating a method for improving the operation of a relational database in accordance with a disclosed embodiment of the invention. The process steps are shown in a linear sequence in FIG. 3 for clarity of presentation. However, it will be evident that some of them can be performed in parallel, asynchronously, or in different orders.

At initial step 48 a query (the “original query”) is received. Next, at step 50 the original query is analyzed and modified by insertion of one or more redundant clauses, using the method described above with respect to FIG. 2.

Next, at step 52 the original query that was received in step 50 is executed in a RDBMS, and its execution time (or other performance measurement) determined.

Next, at step 54 the query as modified in step 50 (the “modified query”) is executed in the RDBMS and its performance determined, using the same metric as was used in step 52.

Control now proceeds to decision step 56, where it is determined if there is a difference in the execution times (or other performance measurement) of the two queries that exceeds a predetermined threshold. This threshold is application dependent, varying with such factors as the size of the database, and the complexity of the query. However, typically a difference of 10% can be used as the threshold for purposes of decision step 56.

If the determination at decision step 56 is negative, then no definite conclusion can be established regarding the query optimizer of the RDBMS. Control proceeds to final step 58, and the process terminates.

If the determination at decision step 56 is affirmative, it has now been established that either there is a design flaw in the RDMBS optimizer, or the RDBMS is misconfigured. In order to learn more, control proceeds to decision step 60. Here it is determined whether the performance of the modified query was better than the performance of the original query.

If the determination at decision step 60 is affirmative, then control proceeds to final step 62. It can now be concluded that the method of query modification described above with respect to FIG. 2 is appropriate for the RDBMS in its current configuration. The modified query should be substituted for the original query.

If the determination at decision step 60 is negative, then control proceeds to final step 62. No additional conclusion can be established.

### More Complex Queries.

The procedure described with reference to FIG. 2 applies also, in a straightforward way, to more complex examples, e.g., involving several tables and/or several columns per table and/or vector versions of the IN/NOT IN predicates. For example, consider the query:

### Query 16

SELECT A.A1, A.A2, D.D1, D.D2

FROM A, B, C, D

WHERE (A.A2, D.D2) NOT IN
(SELECT B.B1, B.B2 FROM B, C
WHERE B.B1=C.C1
   AND B.B3=C.C3)
   AND D.D1=C.C2.

If no involved columns are nullable, step 42 would give the following transformation:

### Query 17

SELECT A.A1, A.A2, D.D1, D.D2
FROM A, B, C, D
WHERE (A.A2, D.D2) NOT IN
(SELECT B.B1, B.B2 FROM B, C
WHERE B.B1=C.C1
   AND B.B3=C.C3
   AND A.A2=B.B1
   AND D.D2=B.B2)
AND D.D1=C.C2.

If, however, some columns are nullable, step 46 would give the following transformation:

Query 18

```
SELECT A.A1, A.A2, D.D1, D.D2
  FROM A, B, C, D
  WHERE ((A.A2 IS NOT NULL AND D.D2 IS NOT NULL
      AND (A.A2, D.D2) NOT IN
            (SELECT B.B1, B.B2 FROM B, C
    WHERE B.B1 = C.C1
        AND B.B3 = C.C3
        AND A.A2 = B.B1
        AND D.D2 = B.B2)
      AND SELECT COUNT (*) FROM
          (SELECT B.B1, B.B2 FROM B, C
      WHERE B.B1 = C.C1
          AND B.B3 = C.C3
          AND (B.B1 IS NULL OR B.B2 IS NULL))) = 0
    )
        OR (SELECT COUNT (*) FROM
          (SELECT B.B1, B.B2 FROM B, C
      WHERE B.B1 = C.C1
        AND B.B3 = C.C3) = 0))
  AND D.D1 = C.C2.
```

### EXAMPLE 1

Comparative tests of Query 4 and Query 5 were conducted on an Intel server, with two Xeon® 2.8 GHz CPU's, and 4 GB of RAM, running Microsoft® Windows Server® 2003, and DB2 Version 8.2.

The two database tables, A and B, each included a single indexed nullable column, column X.

The column X in both tables A and B was of string type, with a maximum length of 32 characters, i.e., VARCHAR (32). Each table was filled with about 50,000 records. Each record consisted of a sequence of 32 pseudo-random capital letters. The two tables had approximately 25,000 records in common. It will be evident from the discussion above that Query 4 and Query 5 are logically equivalent.

Results:

The execution time for Query 4 was five minutes.

The execution time for Query 5 was two seconds.

The result sets of both queries were identical, even in their order of presentation.

### EXAMPLE 2

Using the same conditions as in Example 1, the number of records in Table A and Table B was increased, such that there were 100,000 records in each table. Approximately half of the number of rows were in common. Queries 4 and 5 were rerun.

The execution time of Query 4 was about three hours.

The execution time of Query 5 was about three seconds.

### EXAMPLE 3

Using the same conditions as in Example 1, the number of records in Table A and Table B was maintained at 50,000. However, Table B was adjusted such that every record starting with the letter Z was replaced with a null record. This resulted in approximately 2000 null records in Table B.

It will be apparent from an analysis of the queries, and from the foregoing discussion of Queries 4 and 5 that when there is at least one null record in table B, the result set of both queries must be empty. Nevertheless, a profound difference in the execution time of the two queries was observed.

The execution time of Query 4 was more than four minutes.

The execution time of Query 5 was one second.

### EXAMPLE 4

Under the conditions of Example 1, the column X in both tables was defined as not nullable. In this circumstance, DB2 implements an optional “antijoin” feature, which must be explicitly configured in the RDBMS. When implemented, it is applied to non-nullable columns. Queries 4 and 5 both ran to completion in less than two seconds. It is possible that the antijoin feature would have counter-productive effects in some environments. Thus, although the transformations described herein do not provide any advantage where the antijoin feature is effectively used, it still may be of use in cases where the antijoin feature could be implemented, but needs to be disabled.

### EXAMPLE 5

Under the conditions of Example 1, Queries 4 and 5 were replaced by an almost identical pair, Queries 19 and 20, shown below, in which matching records were deleted instead of being simply read.

### Query 19

DELETE FROM A WHERE X NOT IN (SELECT X FROM B)

### Query 20

DELETE FROM A

WHERE
(A.X IS NOT NULL AND
A.X NOT IN (SELECT A.X FROM B WHERE A.X =B.X) AND
(SELECT COUNT (*) FROM B WHERE B.X IS NULL)=0) OR
(SELECT COUNT (*) FROM B)=0

The results were as follows:

Execution time for Query 19 was more than five minutes.

Execution time for Query 20 was less than two seconds.

### EXAMPLE 6

The following example was performed using a different environment from that of Examples 1-5. The measurements where made on a ThinkPad® R50, with one Pentium® 1.5 GHz CPU, and 1 GB of RAM, running Windows® XP, and MYSQL™ 5.0.18-nt.

The MySQL buffer pool (innodb_buffer_pool_size) was set to 400 MB, large enough to cache the experimental data, and yet not so large as to clog the system. Caching the experimental data in computer memory is important. Otherwise the RDBMS performance measurements regarding query processing would be obfuscated by disc I/O operations, which, in the experimental system of this Example, were much slower (at least by an order of magnitude) than query processing operations.

The same table structure was used as in Examples 1 and 2. However, the tables were enlarged considerably. Table A was filled either with 500,000 or 1,000,000 records (numbers are approximate). Table B was filled with records ranging, in number, from 100,000 to 1,000,000 (in steps of 100,000). Each record consists of a sequence of 32 pseudo-random capital letters. The number of records that are common to both tables is approximately equal to one half the number of records in the smaller table.

The experiment compared the following equivalent “difference” queries. It is assumed than the tables A and B do not contain any null records. Then the equivalence of the two queries is self-evident. If null records were present, the two queries would not be equivalent.

### Query 21

SELECT COUNT(*) FROM A WHERE X NOT IN (SELECT X FROM B)

### Query 22

SELECT COUNT(A.X) FROM A

WHERE
A.X NOT IN (SELECT A.X FROM B WHERE A.X=B.X)

The COUNT operator was chosen in order to reduce the size of the query's output. This avoids undue interference with RDMS performance measurements that would otherwise be caused by I/O operations.

Results:

Queries 21 and 22 were run on different combinations of fillings for Tables A and B. The running times show that the execution time of Query 22 is shorter than the execution time of Query 21. The improvement ranges from 10% to 30%.

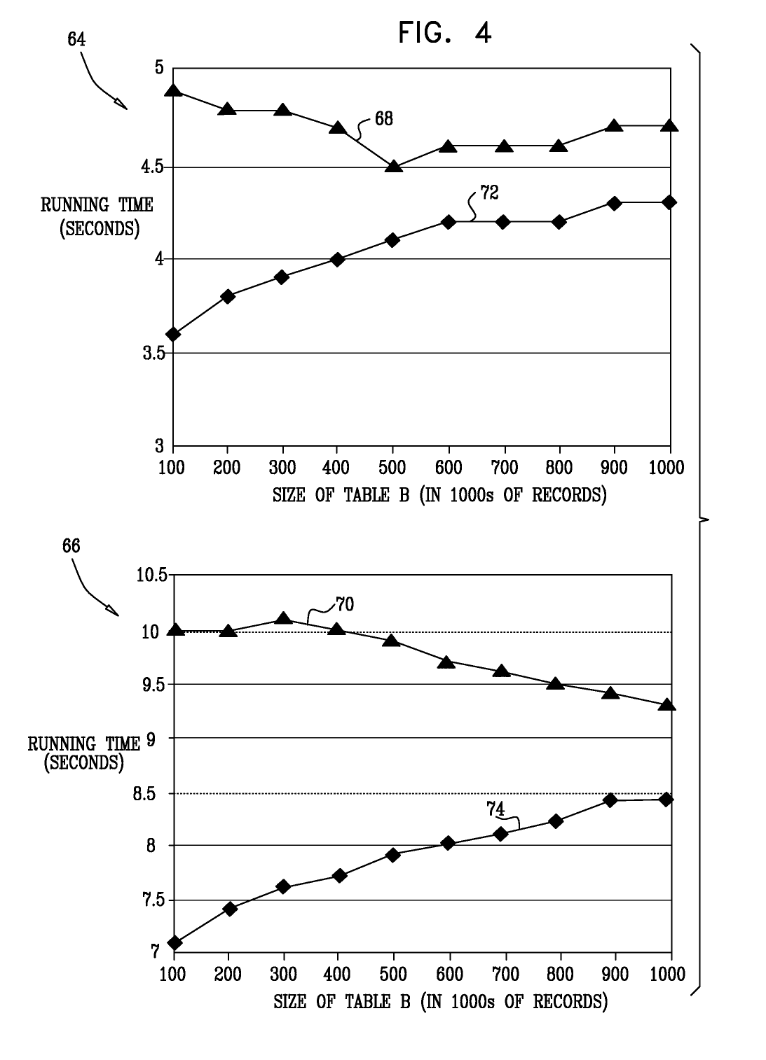

Reference is now made to FIG. 4, which shows two graphs 64, 66 comparing execution times for Queries 21 and 22 for different sizes of Table B, in accordance with a disclosed embodiment of the invention. The graphs 64, 66 show results of runs in which Table A had 500,000 and 1,000,000 records, respectively. The execution times for Query 21 are indicated by lines 68, 70. The execution times for Query 22 are indicated by lines 72, 74. It will be evident from an inspection of the graphs 64, 66 that the execution times for Query 22 are invariably less than corresponding execution times for Query 21.

Additional tests using the environment of this Example showed an even greater performance difference has become even more tangible when using more demanding queries of the form:

### Query 23

A.X−(B1.X″B2.X″B3.x).

Converting Query 23 into the general form of query 24 can make a significant difference in performance:

### Query 24

A.X−((A.X≧B1.X)″(A.X≧B2.X)″(A.X≧B3.X)).

Performance measurements performed using the above-described MySQL RDBMS show an improvement of approximately 25% where Table A contained about 300,000 records, Tables B1, B2, B3 contained about 100,000 records each, the query result included about 150,000 records.

### Testing RDBMS Optimizers.

In the following experiment, TPC-H database benchmark of the Transaction Processing Performance Council (TPC), Presidio of San Francisco, Building 572B, Ruger St., San Francisco, Calif. 94129-0920. The TPC Benchmark™ H (TPC-H) is a decision support benchmark.

Among the 22 TPC-H benchmark, which consists of 22 SQL queries, we identified three queries (benchmark queries 16, 18, and 20), which fall into the pattern of the invention and can be modified. These three queries include the IN or NOT IN operators.

We noticed significant performance degradation for benchmark query #20 on a sub-optimally configured database running on the test system. On investigation, we were able to detect a configuration issue in the query optimizer of the particular RDBMS, and further investigation revealed the problem. When the flaw was corrected, the performance degradation of benchmark query #20 was corrected. Thus, the insertion of constraining clauses as described provides a valuable test of the integrity of a RDBMS query optimizer.

In general, when a RDBMS query optimizer is perfect, or nearly so, the addition of constraining clauses does not substantially improve query performance. In general, a significant performance difference between the original and modified query (FIG. 3) indicates either a design flaw in the RDBMS query optimizer or a suboptimal configuration of the RDBMS, regardless of whether the modified query causes a performance enhancement or a performance degradation as compared with the original query.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A computer-implemented method for evaluating a relational database management system having a query optimizer by optimizing a query to retrieve data from a relational database in a storage device, comprising the steps of:
determining that said query contains a qualifying clause;
modifying said query by adding a redundant clause thereto to produce a modified query;
thereafter executing said query and executing said modified query in said relational database management system; and
evaluating said query optimizer responsively to a difference in a performance measurement of said relational database management system in said steps of executing said modified query and executing said query.

2. The method according to claim 1, wherein said query references a table of said relational database having a nullable column, and wherein said step of modifying said query comprises adding a new clause, which when executed by said relational database management system, causes said relational database management system to report an absence of null records in said nullable column.

3. The method according to claim 1, wherein said qualifying clause specifies inclusion or exclusion of a set of field values in a set of records.

4. The method according to claim 1, wherein said query is a Standard Query Language (SQL) query.

5. The method according to claim 1, wherein said query references a table of said relational database having a nullable column, and wherein said step of modifying said query comprises adding a new clause, which when executed by said relational database management system, causes said relational database management system to report an absence of record entries in said nullable column.

6. The method according to claim 5, wherein said new clause comprises a count operator.

7. The method according to claim 1, wherein said step of modifying said query comprises transforming a WHERE clause in said query having a first form
WHERE A.X IN (SELECT B.X FROM B)
to a second form
WHERE A.X IN (SELECT B.X FROM B WHERE A.X =B.X),
wherein A and B are tables of said relational database, and A.X and B.X are columns of a comparable type in said tables.

8. The method according to claim 1, wherein said step of modifying said query comprises transforming a WHERE clause in said query having a first form
WHERE A.X NOT IN (SELECT B.X FROM B)
to a second form
WHERE (
A.X IS NOT NULL
AND A.X NOT IN (SELECT B.X FROM B WHERE A.X = B.X)
AND (SELECT COUNT (*) FROM B.X WHERE B.X IS NULL)=0
)
OR (SELECT COUNT (*) FROM B) = 0
wherein A and B are tables of said relational database, and A.X and B.X are columns of a comparable type in said tables.

9. A computer software product for evaluating a relational database management system having a query optimizer by optimizing a query to retrieve data from a relational database in a storage device, the product including a tangible computer-readable medium in which computer program instructions are stored, which instructions, when read by a computer, cause the computer to:
determine that said query contains a qualifying clause;
modify said query by adding a redundant clause thereto to produce a modified query;
thereafter execute said query and execute said modified query in said relational database management system; and
evaluate said query optimizer responsively to a difference in a performance measurement of said relational database management system in an execution of said modified query and an execution of said query.

10. The computer software product according to claim 9, wherein said query references a table of said relational database having a nullable column, and wherein said instructions cause said computer to modify said query by adding a new clause, which when executed by said relational database management system, causes said relational database management system to report an absence of null records in said nullable column.

11. The computer software product according to claim 9, wherein said qualifying clause specifies inclusion or exclusion of a set of field values in a set of records.

12. The computer software product according to claim 9, wherein said query is a Standard Query Language (SQL) query.

13. The computer software product according to claim 9, wherein said query references a table of said relational database having a nullable column, and wherein said instructions cause said computer to modify said query by adding a new clause, which when executed by said relational database management system, causes said relational database management system to report an absence of record entries in said nullable column.

14. The computer software product according to claim 13, wherein said new clause comprises a count operator.

15. A relational database management system having a query optimizer, comprising:
a storage device having a relational database stored therein;
a processor executing a program for receiving a query and responsively to said query searching said relational database to retrieve data therefrom, said program comprising a query pre-processor operative to:
determine that said query contains a qualifying clause;
modify said query by adding a redundant clause thereto to produce a modified query;
thereafter execute said query and execute said modified query in said relational database management system; and
evaluate said query optimizer responsively to a difference in a performance measurement of said relational database management system in an execution of said modified query and an execution of said query.

16. The relational database management system according to claim 15, wherein said query references a table of said relational database having a nullable column, wherein said query pre-processor is operative to modify said query by adding a new clause, which reports an absence of null records in said nullable column.

17. The relational database management system according to claim 15, wherein said query references a table of said relational database having a nullable column, wherein said query pre-processor is operative to modify said query by adding a new clause, which reports an absence of record entries in said nullable column.

18. A computer-implemented method for validating a query optimizer of a relational database management system that is linked to a relational database in a storage device, comprising the steps of:
formulating a first query to retrieve data from said relational database;
modifying said first query by adding a redundant clause thereto to produce a second query; and
submitting said first query to said relational database management system;
recording a performance measurement of said first query;
submitting said second query to said relational database management system;
recording a performance measurement of said second query;
determining that said performance measurement of said second query differs from said performance measurement of said first query; and
responsively to said step of determining, concluding that a design flaw exists in said query optimizer.

19. The method according to claim 18, wherein said first query references a table of said relational database having a nullable column, said step of modifying said first query comprises adding a new clause, which when executed by said relational database management system, causes said relational database management system to report an absence of null records in said nullable column.

20. The method according to claim 18, wherein said first query references a table of said relational database having a nullable column, said step of modifying said first query comprises adding a new clause, which when executed by said relational database management system, causes said relational database management system to report an absence of record entries in said nullable column.
